(19) United States
(12) Patent Application Publication
(10) Pub. No.: US 2011/0196518 A1
(43) Pub. Date: Aug. 11, 2011

(54) SERVICES FOR PROTECTION OF A USER'S LEGAL RIGHTS IN A LEGAL EMERGENCY ACCESSIBLE FROM A PROVIDER VIA WORLD WIDE WEB

(76) Inventors: Jason Robert Nassour, Austin, TX (US); Thomas Benjamin Chavez, Austin, TX (US)

(21) Appl. No.: 12/701,814

(22) Filed: Feb. 8, 2010

(51) Int. Cl. G06F 3/01; G06F 17/00

(52) U.S. Cl. 700/94; 715/733

(57) ABSTRACT

Methods and computer program are disclosed for enabling the use of an individual's wireless personal communication device, such as a cellular telephone, e.g. IPhone™, to acquire the information vital to the preservation of the individual's personal and property legal rights in legal emergency situations. A user can activate services for protection of the user's legal rights in a legal emergency situation accessible from a provider via the Internet. A set of instructions for actions to be taken by the user is provided, accessible via the Internet by said communication device. The user can predetermine a time-out period for commencing recording audio/video and transmitting an emergency message to a user-predetermined contact if dialog is interrupted before end of the time-out period. The user's activation location can be detected, and attorneys in the user's activation location can be notified of the user's emergency situation.

### TECHNICAL FIELD

The techniques described herein relate to telecommunications through mobile handheld wireless communication display devices to access information from the World Wide Web, and more particularly to access information related to a user's legal rights in an emergency situation which pose a threat to such user's rights.

### BACKGROUND

Wireless telecommunication devices, such as cellular telephones and like handheld telecommunication devices have become so pervasive that their world wide number is in the order of billions. The wireless telephone industry's rapid expansion has driven cellular telecommunications in all related wireless industries. Consequently, the principles of the techniques described herein would be applicable to any wireless personal communication device and services that could be used to communicate in a cellular telecommunications system. Foremost among all such devices are the IPhone™ line of products marketed by Apple, Inc. The IPhone™ is particularly effective because of its memory capacity and its user interactive features. However, the techniques described herein may be utilized on a wide variety of currently available wireless communication devices, including personal palm devices, Personal Digital Assistants (PDAs), palm devices, any Windows based handheld devices, and Research in Motion Limited's Blackberry devices.

The complexity of most individuals' personal and business lives has been increasing at a rapid pace. Travel and communication can result in unusual environment and situations that can cause an individual to be faced with decisions regarding personal and economic conditions. In such unusual situations, a wrong decision can have very serious adverse consequences. It is important for individuals to know what their legal rights are so that they may make decisions and take actions to protect and preserve such rights. It is not unusual for situations threatening the personal and property rights of individuals to arise suddenly, and with little warning. Some examples of such situations are alleged driving while under the influence, domestic violence, family custody, accident documentation, unknown warrants, immigration and travel issues. It is a fundamental principle of law in all varied jurisdictions and lands that ignorance of the law is no excuse.

### SUMMARY

The techniques described herein enable use of an individual's wireless personal communication device, such as a cellular telephone, e.g. IPhone™, to acquire information vital to the preservation of the individual's personal and property legal rights in legal emergency situations. In accordance with the techniques described herein, a method and computer program are provided wherein a user is enabled to interactively display a list of threatening situations, to select a threatening situation item from said list, and responsive to such user selection, a set of audio and/or visual instructions is provided suggesting initial actions to be taken by said user in order to protect the user's legal rights. These instructions may include a dialog of questions for the user to answer or for the user to ask of others involved in the situation. Dependent upon the answers to these questions, there may be further instructions including further questions. Such an exchange may continue until the user's legal rights have been adequately protected. For best results, the method and computer programs of this invention may be controlled by a service provider accessible via a network, e.g. the World Wide Web or Internet, considered exchangeable herein. The computer program may also be stored locally on the wireless device and upgraded periodically from a service provider. As will be hereinafter described in greater detail, when the method of the techniques described herein is in operation, the controlling computer application program provided from the service provider is stored in whole or at least in part in the RAM memory of the wireless interactive communication display device, e.g. a cellular telephone or IPhone™.

Where the wireless communication device, e.g. IPhone™, enables said user to record audio, the audio recording feature may be automatically activated. Alternatively, one of the instructions may direct a user to commence recording audio. Where the communication device enables video recording, the techniques described herein apply to video recording similarly.

In accordance with an aspect of the techniques described herein, the method may provide an instruction enabling a user to transmit an emergency message to a user's predetermined contact via said network. This will subsequently be described as the “Lifeline” feature. The techniques described herein also contemplate that there may be circumstances wherein the emergency situation may restrain the user from further communication via the method of the techniques described herein. In such situation, the techniques described herein enable the user to predetermine a time-out period for said commenced method, and for the transmitting of an emergency message to the user's predetermined contact if said dialog is interrupted before the end of the time-out period. Otherwise, the transmission of the emergency message to the user's predetermined contact will occur at the end of the dialog. Likewise, when the wireless communication device, e.g. IPhone™, enables said user to record audio and/or video, such recording may be automatically commenced if dialog is interrupted before the end of the time-out period. Otherwise, the audio recording will begin at the end of the dialog. If the user is a subscriber to provider's service, the recording will be transmitted to a server. The user's current location at the time of activation can be analyzed and detected, and attorneys in the user's current location will be notified of the user's plight.

Another aspect of the techniques described herein enable the user to establish a pre-existing attorney-client relationship with a selected attorney, usually through the service provider, and the selected attorney may thus provide the set of instructions and the additional instructions wherein said instructions are attorney privileged. As described below, other features and variations can be implemented, if desired, and a related method can be utilized, as well.

As will be hereinafter described in greater detail, it is a function of the present techniques to provide emergency legal advice to users in potentially threatening situations. The provider of such services accessible via the Internet provides for the enrollment of clients who can access the provider via wireless communication audio/visual handheld devices, such as cellular telephone, e.g. IPhones™. The user may be concerned with only a single potentially threatening legal situation. For example, the user may only be concerned with DWI risks. In such a situation, the user only enrolls for the DWI instructions. On the other hand, the user may enroll for several instruction sets, e.g. Family Violence or Child Custody situations.

Accordingly, when the enrolled user is confronted with an emergency with legal implications, where the user is enrolled for a single situation set, he need only press a single button on the cellular phone to acquire the instruction set of Do's and Don'ts. Dependent upon the convenience of the situation sets, the user will need to select the appropriate situation from a list or menu of situations displayed on the communication device. In the following description of the techniques, whenever audio recording is mentioned or given as an example, it should be understood that, if available, video recording may be used.

### DESCRIPTION OF THE DRAWINGS

It is noted that the appended drawings illustrate only exemplary embodiments of the techniques described herein and are, therefore, not to be considered limiting of its scope, for the techniques may admit to other equally effective embodiments.

FIG. 1 is a generalized diagram of a Web network portion which may be used in the practice of the techniques described herein for wireless communication via cellular communications between a wireless cellular display device and a service provider Web site;

FIG. 2 is a generalized block diagram of a conventional wireless cellular telephone member, such as an IPhone™, which may be used as the receiving telephone;

FIG. 3 is a flowchart of general steps involved in configuring a system for immediately responding to situations threatening a user's legal rights; and

FIG. 4 is a flowchart of general steps involved in using the system for immediately responding to situations threatening a user's legal rights.

### DETAILED DESCRIPTION

The techniques described herein provide a method and system for immediate response to situations threatening a user's legal rights, comprising enabling a user to interactively display a list of threatening situations in a handheld personal communication device having a user interactive display, enabling said user to select a threatening situation from said list, and responsive to said user selection, provide a set of instructions for actions to be taken by said user.

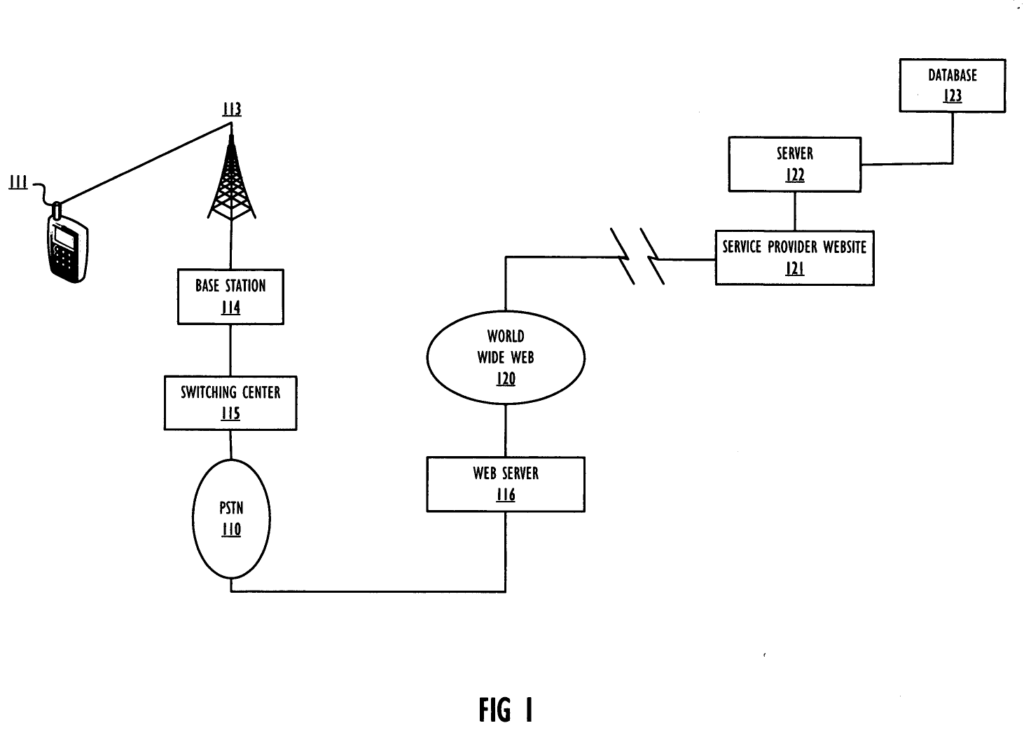

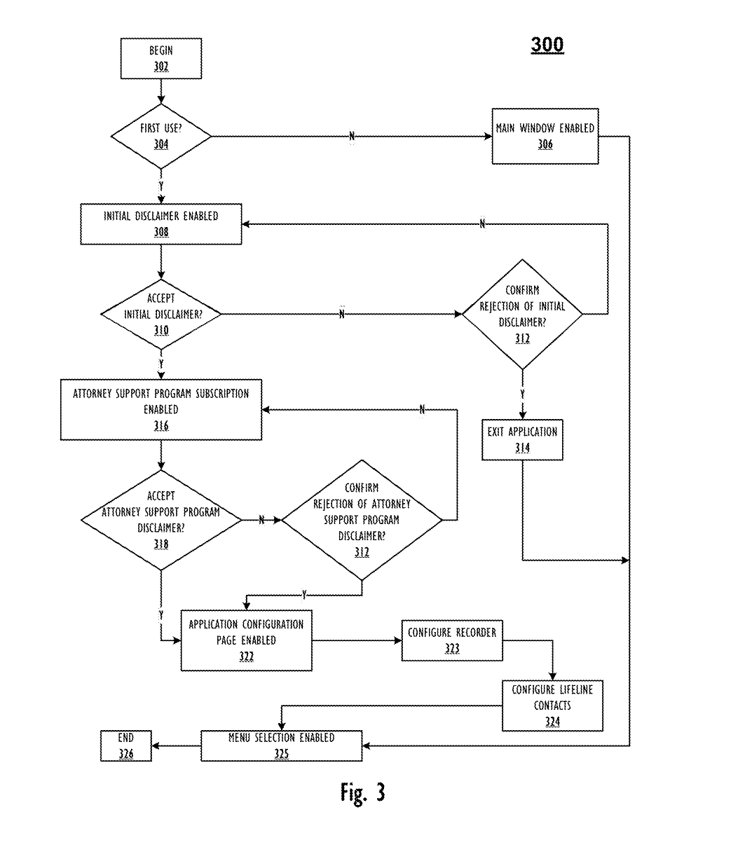

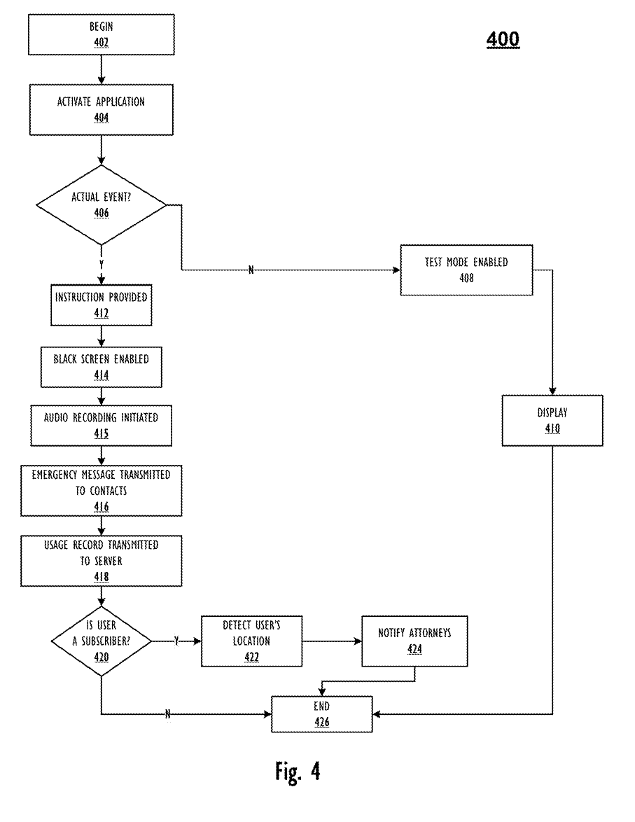

FIG. 1 shows a portion of a conventional cellular telecommunications network system 100, set up so that cellular telephones may receive cellular calls from interconnected telephone network systems using Public Switched Transmission Network (PSTN). This arrangement may be used in the practice of the techniques described herein for wireless communication via cellular communications between a wireless cellular display device, e.g. an IPhone™ and a service provider Web site. Mobile wireless cellular telephone 111 is connected into the PSTN 110 via a cellular telephone communication path to antennae on tower 113. The signals are passed through base stations 114 to switching center 115 which then controls the routing of the calls to PSTN 110, which in turn can route the call through any appropriate Web station server 116 through the World Wide Web 120 or Internet to the Web site of the service provider 121 having appropriate servers 122 to control Web site distribution and functions supported by database storage 123. The functioning of this network system in carrying out the techniques described herein will be hereinafter described in greater detail with respect to FIGS. 3 and 4.

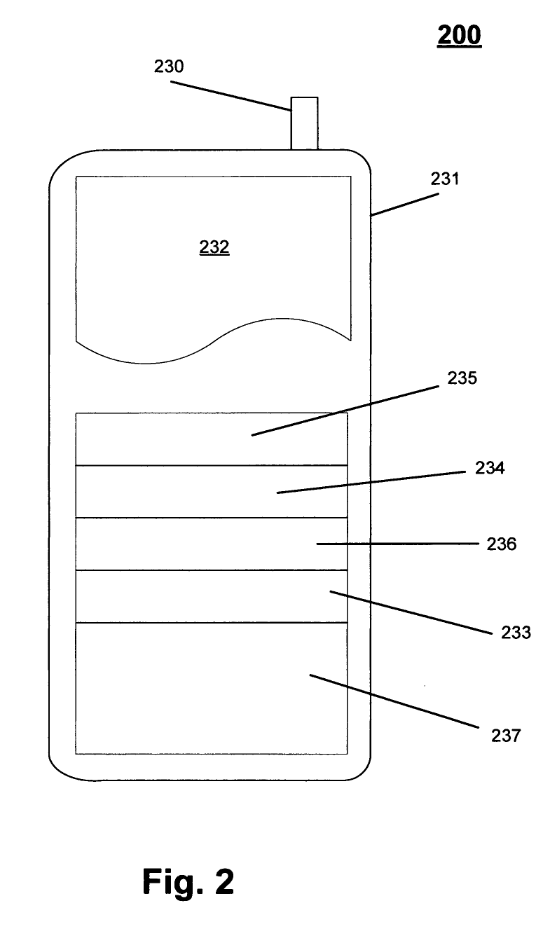

FIG. 2 shows an illustrative cellular telephone member structure 200, such as an IPhone™ which may be used in the practice of the techniques described herein. It should be understood the mobile wireless telephones which may be used in the practice of the techniques described herein may include many other functions not related to the techniques described herein. The illustrative wireless telephone of FIG. 2 includes a housing 231, an appropriate antenna 230, and a display face 232 which may be a conventional touch display for I/O or there may be a keypad for such I/O. In the illustrated telephone 200, the housing and display face have been broken away to show the other elements of the telephone in block form. FIG. 2 shows a data processor 235, operating system 233, a high capacity RAM 236 and a permanent programmable memory, a programmable ROM 234 that may be an EPROM or flash ROM. Because flash ROMs can now provide 8 MB of capacity, many of the application programs and routines including those used in the techniques described herein which are conventionally stored, in whole or in part, on the telephone's RAM may also be stored in this ROM 234. In addition, the telephone operating system 233 and built-in applications 237 are also conventionally stored in the ROM 234. Thus, the cellular telephone housing 231 includes a data processor 235, a programmable ROM 234, a RAM 236 that is shown in an operational state loaded with the telephone's operating system 233, and its application programs 237, including routines required to practice the techniques described herein.

FIG. 3 is a flowchart showing a general overview of the steps in a method for configuring an application for immediate response to situations threatening a user's legal rights 300. The process begins, step 302. A determination is made regarding whether the user is using the application for the first time, step 304. If No, the main window opens or in enabled, step 306, and the user proceeds to the menu selection, step 324, and the configuration process ends, step 326.

In FIG. 3, if Yes, a determination is made that the user is using the application for the first time, step 304, an initial disclaimer opens or is enabled, step 308, and a determination is made whether the user accepts the initial disclaimer, step 310. If No, a determination is made regarding whether the user confirms the user's rejection of the initial disclaimer, which can occur via a pop-up confirmation message, step 312. If No, the process returns to the opening of the initial disclaimer, step 308. If Yes, the user confirms, i.e. via the pop-up confirmation message, that the user does not accept the initial disclaimer, the process requires the user to exit the application, step 314, and the process ends, step 326.

If the user accepts the initial disclaimer from determining step 310, an attorney support program subscription opens or is enabled, step 316, for a user to have the user's location and threatening situation information transmitted as an emergency message to one or more attorneys during a situation that is threatening to the user. It is understood that this transmission can be via one or more of text, email, voicemail, or other similar messaging means. A determination is made regarding whether the user accepts an attorney support subscription program disclaimer, step 318. If No, a determination is made regarding whether the user rejects the attorney support subscription program disclaimer, i.e. confirms unsubscription to the program, step 320. If No, the user rejects the attorney support subscription disclaimer, i.e. does not confirm unsubscription, the attorney support program subscription option opens or is enabled, step 316, and the process continues to the determination step 318 wherein the determination is made regarding whether the user accepts the attorney support program subscription disclaimer, step 318.

If Yes, the user confirms unscubscription in step 320, an application setting page is opened or enabled, step 322, and the menu selection is available to the user, step 324. The configuration of the application ends, step 326. If a determination is made at step 318 that the user accepts the attorney support subscription program disclaimer, the application setting page opens, step 322. A recording feature is configured to be either “ON” or “OFF”, step 323, then lifeline contacts are configured, step 324. Lifeline contacts are predetermined emergency contacts the user would like an emergency message transmitted to during a situation that is threatening to the user. In configuring lifeline contacts, one or more contacts are entered into the program, including contact information for each lifeline contact, such as email address, telephone numbers, cellular telephone numbers that can be used for receiving text messages, and other information that would be useful for transmitting a message to the lifeline contact. A menu selection is available to the user to facilitate configuration and use of the program, step 325, and the configuration of the application ends, step 326.

In one embodiment, the techniques described herein could actively search for warrant information related to the user. If one or more warrants are detected, the warrant situation is classified and a pre-recorded message is transmitted to the user. Depending on the severity of the user's situation, the user will be prompted to resolve the warrant immediately with a payment transaction or will be prompted with attorneys within the jurisdiction of the warrant. A user could enter a payment method into the program, such as credit or debit card information, paypal information, or any other similar means of a payment method. During a threatening situation, the user's payment information can be transmitted to a necessary party to help remedy the user's situation, such as a bail bond agent, attorney, governmental entity, i.e. to pay for outstanding tickets, warrants, or the like.

FIG. 4 is a flowchart showing a general overview of the steps in a method for using an application for immediate response to situations threatening a user's legal rights 400. The process begins, step 402, when the user activates the application, step 404. This can be done by clicking on a logo button for the application, voice recognition, or any similar activation method. A determination is made regarding whether the activation is due to an actual event, step 406. If No, the activation is in error or for other reasons, such as testing the application, the test mode is opened, step 408. The application is displayed, step 410, and the process ends, step 426.

If Yes, the activation of the application is in response to an actual event, instructions are provided, step 412. In one embodiment of the techniques described herein, the instructions comprise a short, pre-recorded audio message. It is understood that the instructions can be provided via visual means, such as a display. Alternatively, the instructions can be live instructions from an attorney authorized by the user to give the user attorney privileged advice. In such an embodiment, the live instructions can be audio, via visual display, or a combination of audio and visual instructions. When the instructions have been provided, or if the instructions step is interrupted, the user's handheld communication device will have a black screen, step 414, and an audio recording by the user's handheld device will begin, step 415.

Emergency messages will be sent to the user's pre-determined contacts or lifelines, step 416. In one embodiment of the techniques described herein, the emergency message will be via SMS or text, but it is understood that voicemail messages, email messages, and other similar types of messages may also be sent either in combination or alone. Included in the message to the lifeline contacts can be a payment method feature that allows the lifeline contact to use a credit or debit card, paypal, or some other similar form of a payment method to help the user during the threatening situation, such as by making payment to a bail bond company, attorney, governmental entity, or the like as determined by the situation. For example, if the lifeline contact can set up a bail payment through the program by responding to a series of questions posed by the program, and the program would forward the gathered information to a bail bond company local to the detected area or zip code where the user is experiencing the threatening situation. A usage record is then sent to the provider's server, step 418. A determination is made regarding whether the user is a subscriber to the provider's program, step 420. If No, the process ends, step 426. If Yes, the user's location is detected, step 422, attorneys in the user's current area at the time of activation are notified, step 424, and the process ends, step 426.

In use, at the point of an impending encounter, the user selects a device interface button on the user's handheld device. The device interface button runs a predetermined algorithm. If the user suspects a traffic stop is due to suspicion of driving while intoxicated, for example, the user can select the device interface button related to such threatening situation Immediately, the user's handheld device will provide instructions either via audio, visual or both, informing the user of the user's rights Immediately following the instructions, the user's device automatically transmits text messages, for example, to the user's lifeline contacts or emergency contacts. The message to the lifeline contacts informs the lifeline contacts of the user's situation and location. One example of such a message is as follows: “This is John Doe. I was just stopped by the [location specific] police. If you don't hear from me in the next hour, it is likely that I have been arrested. My current location is Austin, Tex.”

Further modifications and alternative embodiments of the techniques described herein will be apparent to those skilled in the art in view of this description. It will be recognized, therefore, that the techniques described herein are not limited by these example arrangements. Accordingly, this description is to be construed as illustrative only and is for the purpose of teaching those skilled in the art the manner of carrying out the techniques described herein. It is to be understood that the forms of the techniques described herein shown and described are to be taken as the presently preferred embodiments. Various changes may be made in the implementations and architectures. For example, equivalent elements may be substituted for those illustrated and described herein and certain features of the techniques described herein may be utilized independently of the use of other features, all as would be apparent to one skilled in the art after having the benefit of this description of the techniques. In claims which follow, wherever the term audio is used with respect to recording, it should be understood that audio/video recording is intended to be covered whenever the communication device enables video recording.

What is claimed is:

1. In a handheld wireless personal communication device having a user interactive audio/visual display, a method for immediate response to situations threatening a user's legal rights, comprising:
enabling the user to activate services for protection of the user's legal rights in a legal emergency situation accessible from a provider via the Internet; and
responsive to said user activation, providing a set of instructions for actions to be taken by the user.

2. The method of claim 1, wherein said set of instructions are stored instructions prepared by a service provider accessible via the Internet by said communication device.

3. The method of claim 2, wherein said communication device enables the user to record audio.

4. The method of claim 2, wherein one of said set of instructions is a question requesting the user to select whether the user wishes to be connected to an attorney for attorney privileged advice.

5. The method of claim 4, wherein the user has established an attorney-client relationship with said attorney prior to the activation of said services.

6. The method of claim 2, further including the steps of enabling the user to establish a pre-existing attorney-client relationship with a selected attorney, said selected attorney providing said set of instructions, wherein said instructions are attorney privileged.

7. The method of claim 2, further including the steps of:
enabling the user to predetermine a time-out period for said commenced method; and
commencing recording audio if said dialog is interrupted before end of the time-out period.

8. The method of claim 2, further including the steps of:
enabling the user to predetermine a time-out period for said commenced method;
transmitting an emergency message to a user-predetermined contact if said dialog is interrupted before end of the time-out period;
transmitting usage record to server;
determining whether the user is a subscriber to provider;
detecting the user's location; and
notifying attorneys in the user's detected location of the user's emergency situation.

9. In a handheld wireless personal communication device having a user interactive audio/visual display, a method for immediate response to situations threatening a user's legal rights, comprising:
enabling the user to interactively display a set of threatening situations;
enabling the user to select a threatening situation item from said set of threatening situations; and
responsive to said user selection, providing a set of instructions for actions to be taken by the user.

10. The method of claim 9, wherein said instructions include a dialog of questions to be answered by the user.

11. The method of claim 10, further including a display of additional instructions responsive to said questions answered by the user.

12. The method of claim 11, wherein said set of instructions are stored instructions prepared by a service provider accessible via the Internet by said communication device.

13. The method of claim 11, wherein:
said communication device enables the user to record audio; and
an instruction directs the user to commence recording audio.

14. The method of claim 11, wherein one of said set of instructions is a question requesting the user to select whether the user wishes to be connected to an attorney for attorney privileged advice.

15. The method of claim 14, wherein the user has established an attorney-client relationship with said attorney prior to the activation of said services.

16. The method of claim 11, further including the steps of enabling the user to establish a pre-existing attorney-client relationship with a selected attorney, said selected attorney providing said set of instructions, wherein said instructions are attorney privileged.

17. The method of claim 11, wherein an instruction enables the user to transmit an emergency message to a user-predetermined contact via said network.

18. The method of claim 11, further including the steps of:
enabling the user to predetermine a time-out period for said commenced method; and
commencing recording audio if said dialog is interrupted before end of the time-out period.

19. The method of claim 11, further including the steps of:
enabling the user to predetermine a time-out period for said commenced method; and
transmitting an emergency message to a user-predetermined contact if said dialog is interrupted before end of the time-out period.

20. A computer usable storage medium having stored thereon a computer readable program for immediate response to situations threatening a user's legal rights via a handheld wireless personal communication device having a user interactive audio/visual display, wherein the computer readable program when executed on a computer causes the computer to:
enable the user to interactively display a set of threatening situations;
enable the user to select a threatening situation item from said set of threatening situations; and
responsive to said user selection, provide a set of instructions for actions to be taken by the user.

21. The computer usable storage medium of claim 20, wherein said instructions include a dialog of questions to be answered by the user.

22. The computer usable storage medium of claim 21, wherein the computer program when executed further causes the computer to display a set of additional instructions responsive to said questions answered by the user.

23. The computer usable storage medium of claim 22, wherein said set of instructions are stored instructions prepared by a service provider accessible via the Internet by said communication device.

24. The computer usable storage medium of claim 23, wherein:
said communication device enables the user to record audio; and
an instruction directs the user to commence recording audio.

25. The computer usable storage medium of claim 22, wherein one of said set of instructions is a question requesting the user to select whether the user wishes to be connected to an attorney for attorney privileged advice.

26. The computer usable storage medium of claim 25, wherein said user has established an attorney-client relationship with said attorney prior to the activation of said services.

27. The computer usable storage medium of claim 22, wherein the computer program when executed further causes the computer to enable the user to establish a pre-existing attorney-client relationship with a selected attorney, said selected attorney providing said set of instructions, wherein said instructions are attorney privileged.

28. The computer usable storage medium of claim 22, wherein an instruction enables the user to transmit an emergency message to a user-predetermined contact via said network.

29. The computer usable storage medium of claim 22, wherein said computer program when executed causes the computer to:
enable the user to predetermine a time-out period for said commenced method; and
commence recording audio if said dialog is interrupted before end of the time-out period.

30. The computer usable storage medium of claim 22, wherein said computer program when executed causes the computer to:
enable the user to predetermine a time-out period for said commenced method; and
transmit an emergency message to a user-predetermined contact if said dialog is interrupted before end of the time-out period.

31. A computer usable storage medium having stored thereon a computer readable program for immediate response to situations threatening a user's legal rights via a handheld wireless personal communication device having a user interactive audio/visual display, wherein the computer readable program when executed on a computer causes the computer to:
enable the user to activate services for the protection of the user's legal rights in a legal emergency situation accessible from a provider via the Internet; and
responsive to said user activation, providing a set of instructions for actions to be taken by said user.

32. The computer usable storage medium of claim 31, wherein said instructions are stored instructions prepared by a service provider accessible via the Internet by said communication device.

33. The computer usable storage medium of claim 32, wherein said communication device enables said user to record audio.

34. The computer usable storage medium of claim 32, wherein one of said set of instructions is a question requesting the user to select whether the user wishes to be connected to an attorney for privileged advice.

35. The computer usable storage medium of claim 32, wherein the user has established an attorney-client relationship with said attorney prior to the activation of said services.

36. The computer usable storage medium of claim 32, wherein the computer program when executed further causes the computer to enable said user to establish a pre-existing attorney-client relationship with a selected attorney, said selected attorney providing said set of instructions wherein said instructions are attorney privileged.

37. The computer usable storage medium of 32, wherein said computer program when executed causes the computer to:
enable the user to predetermine a time-out period for said commenced method; and
commence recording audio if said dialog is interrupted before end of the time-out period.

38. The computer usable storage medium of 32, wherein said computer program when executed causes the computer to:
enable the user to predetermine a time-out period for said commenced method; and
transmit an emergency message to a user-predetermined contact if said dialog is interrupted before end of the time-out period;
transmitting usage record to server;
determining whether the user is a subscriber to provider;
detecting the user's location; and
notifying attorneys in the user's detected location of the user's emergency situation.
